(19) United States
(12) Patent Application Publication
(10) Pub. No.: US 2011/0300470 A1
(43) Pub. Date: Dec. 8, 2011

(54) DEVICE AND METHOD FOR THE PRODUCTION OF COMPOUNDS BY PRECIPITATION

(75) Inventors: Armin Olbrich, Seesen (DE); Juliane Meese-Marktscheffel, Goslar (DE); Matthias Jahn, Goslar (DE); Rüdiger Zertani, Goslar (DE); Gerd Maikowske, Goslar (DE); Sven Albrecht, Goslar (DE); Stefan Malcus, Goslar (DE); Josef Schmoll, Gos (DE); Gabriele Christine Schmoll, Goslar (DE); Christian Peter Schmoll, Goslar (DE); Wolfgang Josef Schmoll, Goslar (DE); Volker Schmoll, Goslar (DE); Georg Wilhelm Schmoll, Goslar (DE); Michael Kruft, Brights Grove (CA)

(73) Assignee: H.C. STARCK GMBH, Goslar (DE)

(21) Appl. No.: 12/294,969

(22) PCT Filed: Mar. 20, 2007
(86) PCT No.: PCT/EP2007/052653

§ 371 Date: Feb. 4, 2011

(30) Foreign Application Priority Data
Mar. 31, 2006 (DE) 10 2006 015 538.6

(51) Int. Cl. H01M 4/90; B01D 11/02; C01G 53/04; C25B 11/04

(52) U.S. Cl. 429/527; 204/291; 422/261; 423/594.3

(57) ABSTRACT

The invention relates to a device and a method for the production of compounds by precipitation of solids from solutions, the physical and chemical properties of the solid particles formed on precipitation being flexible and can be independently fixable. Custom products can thus be produced with very high space-time yields and a particulate nickel/cobalt mixed hydroxide of formula NiₓCo₁₋ₓ(OH)₂, with a BET surface area of 20 m²/g and a tap density of greater than 2.4 g/cm³.

The present invention relates to a device and a process for the preparation of compounds by precipitation of solids from solutions, wherein the physical and chemical properties of the particles of solid that are formed in the precipitation can be adjusted very flexibly and independently of one another and tailor-made products can thus be prepared with a very high space-time yield.

Many technically important solid compounds are prepared by precipitation from solutions, suitable solvents for this purpose being water, organic compounds, and/or their mixtures. This can be achieved for example by rapid cooling, sudden reduction of the solubility of the compound to be precipitated, by admixing a further solvent in which the compound is sparingly soluble, or by chemical reaction, in which the compound sparingly soluble in the solvent is formed to start with. The solid phase newly formed in the precipitation by homogeneous formation of nuclei consists of many small primary crystallites, which form secondary particles by agglomeration or attach themselves to already existing secondary particles.

Precisely defined requirements are as a rule placed on the quality of the primary and secondary particles in order to achieve desired application properties. The properties of the primary crystallites and of the agglomerates formed therefrom depend of course on the process, parameters. The number of relevant process parameters may be relatively large depending on the particular circumstances. The chemico-physical process parameters include for example the temperature, concentration of the educt solutions, concentration of excess precipitation reagent in the mother liquor, concentration of catalysts, pH value, ionic strength, etc. The most important process parameters, which tend to be technical plant parameters, are residence time, solids concentration, mechanical energy input, reactor geometry, nature of the thorough mixing with stirrers of various types or pumps. The principal technical adjustments include of course also the choice of a batch procedure or a continuous procedure. Continuous precipitation processes permit a uniform product preparation. Naturally certain ranges exist for the process parameters, within which they can be adjusted. Thus, the educts in the educt solutions have a maximum solubility, which cannot be exceeded. This accordingly defines the maximum possible solids concentration in the product suspension. This may however for example also be restricted in the mother liquor by the solubility limit of neutral salt possibly formed in the precipitation reaction. In addition it may be necessary to operate with neutral salt concentrations that are lower than those resulting naturally from the educt concentration. The problem often arises that the adjustment of the process parameters, which influences the properties of the primary particles, is not optimal or is even counter-productive for the desired properties of the secondary particles. The skill therefore consists in finding an adjustment of the process parameters that leads to an acceptable compromise as regards the properties of the primary and secondary particles.

A number of subsidiary conditions therefore exist which complicate the defined adjustment of product properties. Moreover some product properties, such as for example specific surface, porosity, tap density, bulk density, grain size distribution, flowability, crystallite size, etc., cannot be achieved, although this often appears possible without the existing restrictions. For example, with some metal hydroxides it is found that the specific surface under the existing reaction conditions falls strictly linearly with increasing solids content, although the extrapolated solids content for the desired specific surface cannot be adjusted since it lies above the naturally occurring solids content.

Pure or mixed transition metal hydroxides, to name but one example, which as a rule can be prepared by precipitation processes, are important components or precursors of modern rechargeable high performance batteries. Thus, for example, nickel hydroxide doped with cobalt and zinc forms the active component of the positive electrode in nickel-metal hydride and nickel-cadmium batteries (Z. Kristallogr. 220 (2005) 306-315). For the known nickel-metal hydride batteries, for example, nowadays as a rule electrodes based on foam technology are employed, which require the use of the positive active material in the form of spheroidal particles.

Likewise, spheroidal particles are used in the increasingly important rechargeable lithium ion/polymer batteries. For some considerable time attempts have been made worldwide, mainly for economic reasons, to replace partly or even completely the expensive cobalt (in the form of LiCoO₂) hitherto contained in the lithium ion/polymer batteries. To this end inter glia compounds of the metals Ni, Mn and Al—such as for example Li(Ni, Co, Mn)O₂ or Li(NI, CoAl)O₂, have been intensively investigated. The first step consists here in the preparation of corresponding spherical hydroxide precursors, which are synthesised by Co precipitation and optionally can subsequently also be coated, in order then to convert the precursors by thermal treatment into the respective oxidic end product, under the addition of a lithium component.

Depending on the type of battery, manufacturer and use of the battery, nowadays a very wide range of material compositions are used, and the manufacturer of the spherical hydroxides is confronted with a whole range of widely different specifications, which furthermore often include very strict tolerance limits as regards chemical properties and in particular physical properties. It is obvious that, in order to be able to produce products economically to any extent at all, this problem cannot be tackled by a considerable number of different production plants, but only by a very flexible plant and technology that can be adjusted to the respective requirements, and which is nevertheless very stable and operates in a defined manner. As a rule all essential chemical and, of course, in particular physical properties, such as for example particle size distribution, tap density, specific surface and microcrystalline composite (crystallite size), must be precisely predefined in the specifications. All these substance properties depend on a whole number of process parameters (such as for example educt, neutral salt and solids concentrations, residence time, temperature, energy input, etc.), and these naturally do not act completely in the same way on the predefined product properties. For this reason it is a particular requirement to be able to realise specific product combinations, for example of the hydroxidic precursors—and this having regard to the required economic efficiency—as far as possible in a single, universally adjustable plant system.

More specifically it is not possible, for example for physical reasons, to maximise simultaneously the porosity and the tap density of a spheroidal material, since these two properties are contradictory. There exists however a number of dependencies between individual product properties that can be displaced within certain limits. The skill now consists in finding the various combinations of the plant parameters and implementing them in practice with as far as possible a single plant technology, which permits an at least partially independent adjustment of the physical product properties of the hydroxidic battery precursors important for the battery performance.

The continuous production of spherical nickel hydroxide is described in JP Hei 4-68249. For this, a nickel salt solution, alkali and aqueous ammonia solution are continuously added to a heated stirred vessel equipped with an overflow. The stationary state in the reactor system is reached after 10 to 30 hours, following which a product of constant quality can continuously be removed. The mean residence time in the reactor is 0.5 to 5 hours. In this process the solids concentration in the suspension and the neutral salt concentration in the mother liquor are necessarily coupled via the stoichiometry of the precipitation reaction. In addition the temperature-dependent solubility limit of the neutral salt formed in the reaction determines the maximum achievable solids concentration in the suspension. It is of course not possible in a process according to JP Hei 4-68249 to achieve very high solids concentrations in the suspension, for example concentrations that are higher by a multiple, or that are independent of the neutral salt concentration.

EP 0658514 B1 discloses the continuous precipitation of metal hydroxides by decomposing amine complexes in the presence of alkalis in a driving jet reactor. In this connection the educts, in contrast to a stirred reactor, are mixed with the reaction medium by the exiting jet of a nozzle. The restrictions described in JP Hei 4-68249 regarding the increase of the solids concentration in the suspension also apply to the process that is described in EP 0658514 B1.

US 2003/0054252 A1 describes active materials for lithium batteries, as well as their production. A batchwise operating apparatus is recommended for the precipitation of the precursor compounds, which comprises an external circulation of clear mother liquid, which is pumped from the upper region of the reactor and introduced laterally into a dropping pipe, through which the mother liquor flows back again from underneath into the reactor. This upwards flow prevents particles that are too small being able to pass through the dropping tube into the receiving vessel for the end product. Only the particles which have reached a certain minimum size can sink in this receiving vessel. The process described in US 2003/005452 for the production of precursors by precipitation does not permit the independent adjustment of the process parameters. A direct intervention in the development of the grain size distribution by a defined removal of a fine grain fraction from the suspension is not possible with this process.

The object of the present invention was accordingly to provide a device and a process with which the ranges of the individual process parameters (for example concentration of the educts, solids content in the suspension, salt concentration in the mother liquor) can be adjusted independently of one another and thus a maximum flexibility of the process for the production of solid compounds by precipitation from solutions can be achieved by expanding existing degrees of freedom and creating new degrees of freedom. The object of the present invention was also to provide an apparatus and a process which permit a controlled intervention in the development of the particle size distribution during the precipitation process. A further object of the present invention also consisted in providing a device and a process which enable the maximum solids concentration achievable according to the prior art to be increased to a multiple.

This object was achieved by the construction of a device forming a reactor with an integrated inclined clarifier, hereinafter termed “integrated reactor/clarifier system (IRCS)”, FIGS. 1 to 3, and the use of the IRCS as the central unit in combination with further apparatuses (e.g. filters, vessels, pumps, etc.) in a process, in which after the precipitation of compounds with the formation of product suspension consisting of product and mother liquor, mother liquor and particles are removed via the inclined clarifier, so that a controlled intervention in the particle size distribution and an increase of the solids concentration by a multiple can be achieved.

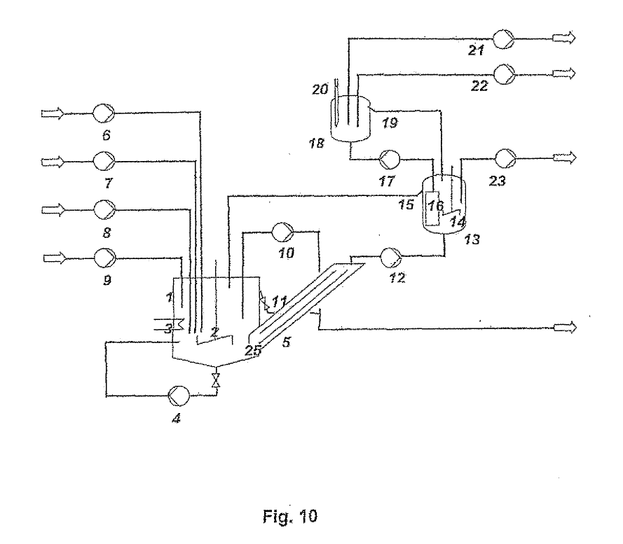

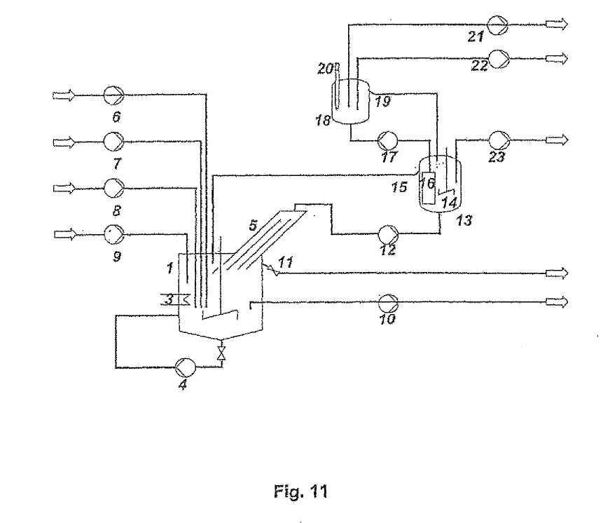

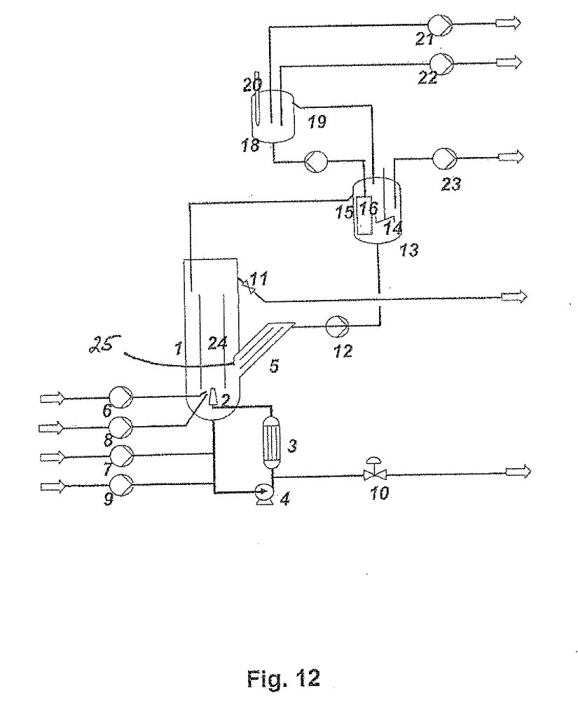

The present invention accordingly provides an integrated reactor/clarifier system (IRCS). The reactor may be a cylindrically shaped device, FIGS. 4 and 5 (6), or a parallelepiped shaped device, FIGS. 1 to 3 (1), with a flat or curved or conically shaped floor. The floor of the reactor may be provided with an opening through which suspension can be removed, if necessary with the help of a pump, and pumped back into the reactor, FIGS. 4 and 5 (14). In order to obtain a homogeneous precipitation product, it is important that the educts are thoroughly mixed on entry into the reactor. This type of reactor may also be operated as a stirred reactor, FIGS. 1 to 3. In this case disc stirrers, propeller stirrers, inclined blade stirrers, INTERMIG stirrers or other stirrers adapted to the specific stirring problem are used. The choice, arrangement and dimensioning of a suitable stirrer are described for example in Ziokarnik, Rührtechnik, Theorie and Praxis, Springverlag 1999. The design of the stirred reactor decisively influences the particle size and the particle size distribution, as well as the settling behaviour of the particles in the reactor. The precipitation processes in the IRCS according to the invention may, depending on the product, be carried out at room temperature as well as at lower or higher temperatures. The temperatures during the precipitation process in the IRCS according to the invention may therefore range from −20° C. to 100° C. The precipitation processes are preferably carried out at temperatures from 20° to 90° C. and particularly preferably at temperatures from 30° to 70° C. Particularly good results in the production of for example battery precursors, such as nickel oxides, nickel hydroxides, Ni/Co mixed oxides or Ni/Co mixed hydroxides, are achieved at temperatures in the range from 30° to 70° C. The process temperatures are, if necessary, adjusted and regulated by heating or cooling via a heat exchanger, FIG. 10 and FIG. 11 (4). If an external circulation is employed, the heat exchanger may also be incorporated in this, FIG. 12 (3).

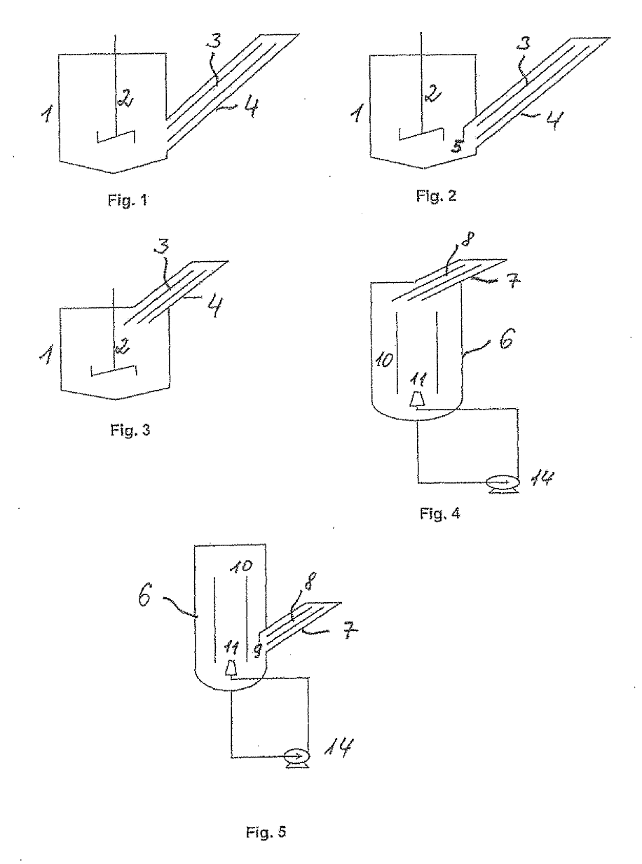

The inclined carrier may be located at any suitable point in the reactor, for example may be mounted above on the reactor, FIG. 3 (4) and FIG. 4 (7). In order to reduce the installation height, the inclined clarifier may also advantageously be mounted underneath the reactor, FIG. 1 and FIG. 2 (4) and FIG. 5 (7). The LRCS is used for the precipitation of chemical compounds from solutions. In the inclined clarifier the mother liquor together with a defined fine grain fraction of the solids is separated from the product suspension. This turbid liquid containing a few g/l of solids is for the most part recycled to the reactor and purified again with the product suspension. By withdrawing a part of this turbid liquid some fine fraction is removed from the product suspension and the particle size distribution is displaced to higher D₅₀ values. A further purpose of the inclined clarifier is to provide a pre-clarified liquid containing only a small amount of solids, from which clear mother liquid can be separated in a simple mariner by filtration.

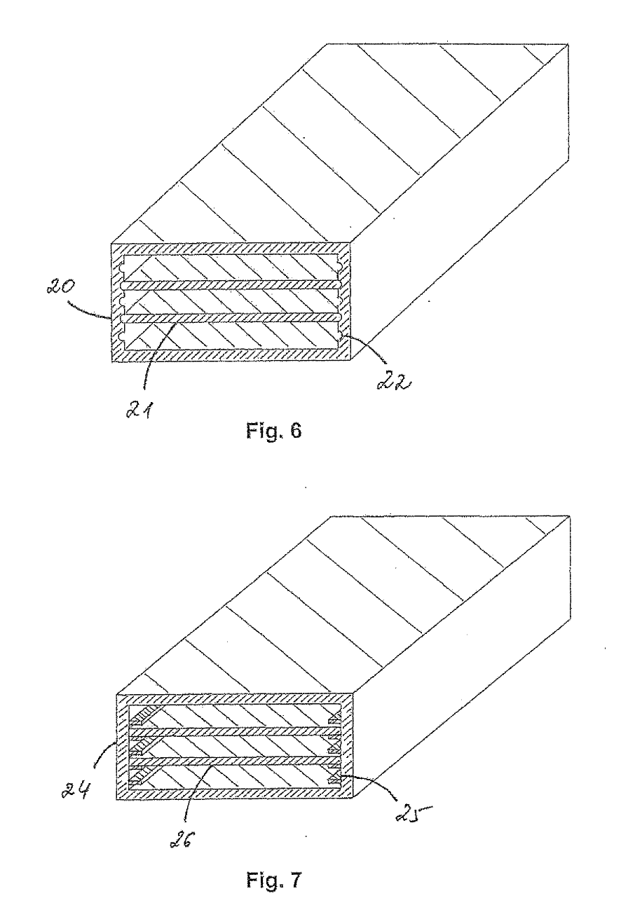

In order to improve the separating efficiency of the inclined clarifier, one or more lamellae (plates), FIG. 1 (3), FIG. 3 (3), FIG. 4 (8) and FIG. 5 (8) may be incorporated, on which solids particles, after they have reached the surface of the lamellae through sedimentation, slide down into the homogeneously thoroughly mixed suspension. The lamellae are arranged in the inclined clarifier in a plane-parallel manner with respect to the floor surface of the clarifier. The lamellae form rectangular plates, which may consist of plastics, glass, wood, metal or ceramics. Depending on the material and product, the lamellae may be up to 10 cm thick. Lamellae 0.5 to 5 cm thick, particularly preferably 0.5 to 1.5 cm thick, are preferably used. The lamellae are fixedly incorporated in the inclined clarifier. They may also be able to be removed, FIG. 6 (21) and FIG. 7 (26). In this case they are inserted into the inclined clarifier via the rail system laterally installed on the insides of the inclined clarifier, FIG. 7 (25), or via grooves, FIG. 6 (22). The rail system may also, be designed in a height-adjustable manner, which provides the inclined clarifier with a high degree of flexibility as regards the choice of the lamellar interspacings. The inclined clarifier may be cylindrical in shape, with a round cross-section, or parallelepiped in shape with a rectangular cross-section, FIG. 6 (20) and FIG. 7 (24). So that the particles can slide down without blocking the inclined clarifier, the angle of the inclined clarifier with respect to the horizontal is 20° to 85° , preferably 40° to 70° and particularly preferably 50° to 60°. The inclined clarifier may also be mounted via a flexible connection on the reactor. In this embodiment the angle may be variably adjusted during the process.

In a preferred embodiment the inclined clarifier contains at the inflow to the interior of the reactor a plate, FIG. 2 (5) and FIG. 5 (9), which is arranged in a plane-parallel manner relative to the opening of the entry surface of the inclined clarifier. This plate prevents the inclined clarifier from being blocked in the inflow region by highly concentrated suspension.

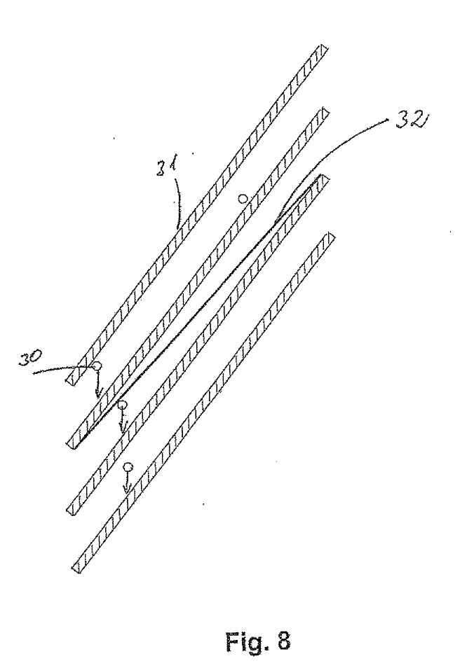

In order the better to understand the mode of operation of the IRCS according to the invention, a detailed explanation will now be given on the basis of FIG. 8.

The solids particles (30) sink at a constant velocity in the inclined clarifier, FIG. 8, depending on their shape and size. Assuming for example that Stokes' law applies, then the sinking velocity for spherical particles due to the effective weight is proportional to the square of the particle diameter. The upwards component of the velocity of the laminar flow in the inclined clarifier is now superimposed on this sinking velocity. All solids particles whose sinking velocity is less than or equal in magnitude to the upwards component of the liquid flow cannot sink to the surface of a lamella (31) or to the floor surface of the inclined clarifier and are consequently removed with the overflow of the inclined clarifier.

If the sinking velocity of the particles is greater in magnitude than the upwards component of the liquid flow, the particles undergo a downwards movement at a constant sinking velocity. Whether or not such a particle is removed with the overflow from the inclined clarifier depends, for a constant flow velocity of the liquid, on the vertical distance of the particle to the lamella on entering the inclined clarifier, as well as on the length and the angle of inclination of the inclined clarifier.

It can easily be seen that a critical particle radius r₀ exists, so that all particles with r>r₀ are completely retained by the inclined clarifier. The straight line (32) in FIG. 8 shows the part of a particle with the limiting radius r₀. The paths of all particles whose radius is greater have a smaller angle with respect to the horizontal and therefore impact with certainty a lamella or the floor plate. This means that they are retained. By adapting the ratios in the inclined clarifier, in particular the flow velocity of the liquid, an upper limit for the particle diameter of the fine particles that leave the inclined clarifier in the overflow can thus be adjusted.

So long as the overflow of the inclined clarifier flows back via a circulation vessel into the stirred reactor, nothing changes in the overall system. If some of the liquid that is turbid due to the fine fraction of the solids is removed from the circulation vessel by means of a pump, then a defined fraction of the fine grain material is extracted and direct intervention in the development of the particle size distribution can be effected. This constitutes a new variation possibility for controlling precipitation processes, whereby the particle size as well as the particle size distribution can be influenced independently of the other plant parameters.

Due to the aforedescribed removal of turbid liquid (suspension), the solids concentration of which on entry into the circulation vessel is typically 0.5 to 5% of the solids concentration reactor, naturally the solids concentration of the suspension in the reactor is also increased at the same time, since with the targeted removal of the fine grain fraction a disproportionately large amount of mother liquor is extracted from the overall system. As a rule this is desired, but is undesirable if the solids concentration in the reactor should be held at a low level and the increase of the solids concentration cannot be satisfactorily counteracted by adjusting other substance streams. Depending on its amount and specification this fine fraction can then be mixed again with the product suspension. The separation in the reactor/clarifier system is decisive.

In this case it is possible to remove mother liquor from the circulation vessel via a filter element, FIG. 10 (16), and pump it back directly into the reactor in order to increase the solids concentration of the turbid liquid (suspension). On discharging the same amount of fine grain material less mother liquor is then removed. Fine grain material denotes those particles whose size does not exceed 30% of the D₅₀ value of the particle size distribution. It may also be advantageous in the circulation vessel to remove only mother liquor from the system via the filter element. In this way the solids content in the reactor can firstly be raised to a multiple of the stoichiometric solids concentration, and secondly a decoupling between the concentration of neutral salt possibly formed in the precipitation reaction and the solids concentration can be achieved. The concentration ratio of solids to salt in the reactor can, due to the possibility of removing mother liquor, be increased for example not only by raising the solids concentration at constant salt concentration, but also by the fact that at constant solids concentration salt-free solvent is added to the reactor and at the same time the equivalent amount of mother liquor is removed from the system via the filter element.

The achievement of the additional degrees of freedom with the simultaneous increase in the flexibility of the IRCS according to the invention will be described in more detail by the example of the two parameters salt concentration and solids content for the general reaction AX+BY=>AY_{solid}+BX_{diss.} AX and BY will denote the educts in the educt solutions and BX will denote dissolved salt in the mother liquor. AY denotes the product occurring as insoluble solid.

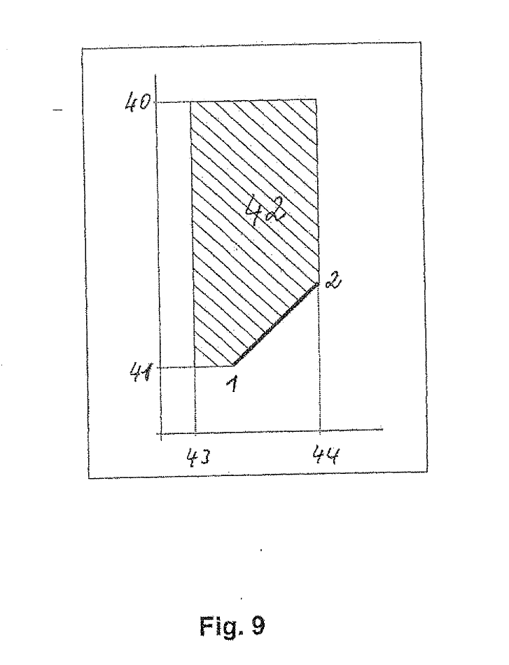

The expansion of the existing degrees of freedom and creation of new degrees of freedom for the aforementioned reaction is illustrated diagrammatically in FIG. 9, where:

(40)—technical limit,

(44)—chemical limit,

(41,43)—economic limit.

In FIG. 9 the section shown in bold type as (1-2) denotes the region which according to the prior art is available for varying the two process parameters neutral salt concentration -in the mother liquor and solids concentration in the suspension. This straight line is bounded upwardly by the solubility of the salt BX, while downwardly there exists an economic limit for a minimum solids content. On account of the stoichiometry of the reaction one is therefore restricted as regards these two parameters to a one-dimensional space corresponding to the prior art. With the aid of the IRCS according to the invention and the process according to the invention this one-dimensional region is expanded to a two-dimensional region (42), so that the maximum solids concentration can be increased by a multiple and at the same time the minimum salt concentration can be significantly reduced, and all combinations of the now expanded regions for the solids concentration and the neutral salt concentration can be adjusted. The flexibility thereby gained in the conduct of the process is immediately evident. A movement in the diagram vertically upwards corresponds to removal of mother liquor and results in the corresponding increase of the solids concentration. A movement in the diagram horizontally to the left corresponds to the addition of extra solvent with at the same time removal of the corresponding amount of mother liquor.

The IRCS according to the invention can be operated as an open system as well as a closed system. A closed system is for example a driving jet reactor, which is shown in FIG. 4 and. FIG. 5 (6) and also in FIG. 12 (1). In this reactor the inclined clarifier can be arranged in the upper region, FIG. 4 (7), as well as in the lower region, FIG. 5 (7). The educts are here introduced through one or more nozzles into the reaction zone of the reactor, where they undergo an intensive mixing and homogenisation, FIG. 12 (2) and FIGS. 4 and 5 (11). The IRCS according to the invention can be used for precipitations that take place batchwise. The IRCS is however preferably used for precipitation processes in a continuous operation mode.

The invention furthermore relates to a process for the preparation of compounds by precipitation, in which the individual process parameters (for example concentration of the educts, solids content in the suspension, salt concentration in the mother liquor), can be adjusted independently of one another during the precipitation and in this way a controlled intervention in the development of the particle size distribution takes place during the precipitation process and consequently tailor-made products having defined physical properties can be produced particularly economically and with a very high space-time yield.

The invention accordingly provides a process for the preparation of compounds by precipitation, consisting of the following steps:
Provision of at least a first and a second educt solution,
Combined feed of at least the first and the second educt solution to a reactor according to claim 1,
Generation of a homogeneously intensively mixed reaction zone in the reactor,
Precipitation of the compounds in the reaction zones and formation of a product suspension consisting of insoluble product and mother liquor,
Partial separation of the mother liquor from the precipitated product via the inclined clarifier,
Preparation of a precipitation product—suspension, the concentration of which is greater than the stoichiometric concentration,
Removal of the product suspension from the reactor,
Filtration, washing and drying of the precipitated product.

The educt solutions in the process according to the invention are introduced into the reactor with the aid of a pump system. If this involves the IRCS according to the invention with a stirred reactor, the educts are mixed using the stirrer. If the IRCS is designed in the form of a driving jet reactor, the mixing of the educts is effected by the exiting jet from a nozzle, FIG. 12 (2). In order to achieve an even better mixing of the educts, air or an inert gas may additionally also be added to the reactor. In order to achieve a uniform product quality, it is necessary for the educts to be homogeneously thoroughly mixed in the reaction zone of the reactor. A precipitation reaction in which the product and the mother liquor are formed commences already during the mixing and homogenisation of the educts. The product suspension is enriched in the lower reactor part to a desired concentration. In order to achieve a targeted enrichment of the product suspension, in the process according to the invention the mother liquor is partially removed via the inclined clarifier, FIG. 10 (5). The partial separation of the mother liquor by removing the inclined clarifier overflow preferably takes place with the aid of a pump. The solids content of the overflow may contain up to 50%, preferably up to 30%, particularly preferably up to 15% and especially preferably up to 5% of the product suspension. The maximum particle size in the overflow plays an important role in the development of the grain size distribution during the precipitation process. The particles in the overflow are termed fine grain material. This maximum particle size in the overflow may be up to 50%, preferably up to 40% and particularly preferably up to 30% of the D₅₀ value of the particle size distribution. In the process according to the invention a concentration of the precipitation product suspension is achieved that may be a multiple of the stoichiometrically possible concentration of the precipitation product. This may be up to 20 times higher than the possible stoichiometric value. In order to achieve a particularly high product concentration in the suspension, it is necessary partially to remove a large amount of the mother liquor. Even up to 95% of the mother liquor may be partially separated. The amount of the mother liquor to be partially separated depends on the chosen process parameters such as educt concentrations, salt concentration of the mother liquor as well as the solids concentration of the suspension.

The process according to the invention is illustrated diagrammatically in FIG. 10 and is described as follows hereinafter for the purposes of a better understanding:

Educt solutions, possibly catalyst solutions as well as solvents, are fed to a stirred reactor (1), equipped with a speed-regulated stirrer (2), heat exchanger (3), optionally a circulation pump (4) and an inclined clarifier (5), which comprises a height-adjustable plate (25) arranged in a plane-parallel manner with respect to its inlet opening, and into the homogeneously thoroughly mixed reaction zone of the integrated reactor/clarifier system according to the invention (IRCS). The product suspension that is formed is removed by the pump (10) via a filling level regulation unit or flows over via the free overflow (11). When large particles are formed it may be advantageous to operate the circulation pump (4) in order to avoid the danger of sedimentation.

Depending on the height of the inclined clarifier (5) optionally in a self-aspirating mode, the pump (12) conveys liquid with a very low concentration of fine grain material from the clarifier into the vessel (13) equipped with a stirrer (14), from where the liquid can flow back from the free overflow (15) into the reactor (1). A separation size exists depending on the volume flow of the liquid and the dimensioning of the inclined clarifier attachment, so that only particles whose size lies below this separation size are conveyed to the circulation vessel (13). So long as all the suspension removed with the pump (12) flows back via the free overflow (15), naturally nothing changes as regards the reactor (1). A change occurs only if mother liquor and/or solids particles are removed from the system. The removal of mother liquor will first of all be described hereinafter:

The pump (17) withdraws the clear mother liquor from the vessel (13) through a filter element (16), for example a filter hose also used in cross-current filtrations, and conveys the mother liquor to the second circulation vessel (18). From this vessel the pump (21) conveys sample solution continuously or at specified time intervals to the—preferably automatic—analysis stage of the mother liquor. A continuous monitoring, for example by measuring and controlling the pH value with the probe (21), may also be carried out directly in the circulation vessel (18) containing clear mother liquor. The IRCS according to the invention thus enables the composition of the mother liquor to be controlled in a simple way during the whole precipitation procedure, which naturally is very difficult in a suspension with a high solids content. If now mother liquor is removed from the system from the circulation vessel (18) via the pump (22), the solids concentration in the reactor (1) can be adjusted independently of the educt concentrations. In this way the solids concentration of the suspension is also decoupled from the concentration of salts in the mother liquor, which are formed as by-product in many precipitation reactions.

The natural solids concentration may be increased by a multiple, and the space-time yields that can be achieved thereby cannot be realised, or only with great difficulty, by conventional methods. The direct removal of mother liquor via a cross-current filtration, which is incorporated for example in the circulation of the pump (4) of the reactor (1), is not practicable since blockages would constantly occur due to the high solids concentration, which is an obvious disadvantage.

If for example BaSO₄ is precipitated from Ba(OH)₂ solution and sulfuric acid, then water is formed as by-product and the decoupling is reduced to the process parameters Ba concentration and H₂SO₄ concentration in the educt solutions and BaSO₄ concentration in the product suspension. In the precipitation of nickel hydroxide from for example nickel sulfate solution and sodium hydroxide, sodium sulfate is formed as by-product. The solids content of the suspension and the salt concentration can now be adjusted independently of one another. The increase in the solids content has just been described above. If it is also desired to adjust the salt concentration independently of the educt concentrations, water can be introduced into the system via the pump (9) and the corresponding amount of mother liquor can be removed via the pump (22), so that for example a predetermined solids concentration is maintained.

An essential feature of the process according to the invention as well as of the integrated reactor clarifier system (IRCS) according to the invention is also the extraction of a defined fraction of fine grain material from the reaction system, by the removal of suspension from the system via the pump (23), so as thereby to intervene directly in the development of the particle size distribution of the product. As has already been described in more detail above, for the solids particles in the circulation vessel (13) an upper grain size exists, which is determined by the dimensioning of the inclined clarifier attachment (5) and the circulation amount of the pump (12). The stirrer (14) ensures that these fine particles are distributed homogeneously in the liquid. A defined removal of a fine grain fraction from the overall system and thereby also from the reactor (1) is possible in this way. As a rule the fine grain fraction accounts for only a small percentage of the total mass, but its amount decisively influences the development of the grain distribution of the solids produced in the reactor. A direct intervention in the growth mechanism of the particles in a precipitation reaction is not possible with the conventional processes according to the prior art, and has been realised here for the first time. The possibilities thereby opened up are numerous. Not only can the D₅₀ value of the particle size distribution be displaced in a controlled manner, but it is also possible to adjust the width of the distribution. The process can thus be better controlled by this new degree of freedom, and in particular spherical particles with a larger average grain size can be produced than would otherwise be possible under the reaction conditions.

The process according to the invention illustrated in FIG. 11 differs from the process described above and illustrated in FIG. 10, in that here an integrated reactor clarifier system with an inclined clarifier is used, which is arranged above the reactor. FIG. 12 shows a process according to the invention in which the precipitation reaction takes place in a closed IRCS (1) designed as a driving jet reactor.

With the IRCS and process according to the invention numerous chemical compounds can be prepared, whose physical properties, such as for example grain size, grain size distribution, bulk density, tap density, particle shape, etc., can be purposefully influenced, so that tailor-made products can be obtained at the end of the process. Such compounds include for example carbonates or basic carbonates of cobalt, nickel or zinc, to which various doping elements can be added. The process according to the invention is also preferably used for the preparation of zinc oxides, copper oxides or silver oxides. Furthermore, the IRCS and process according to the invention are particularly suitable for preparing tantalum oxides, niobium oxides, tantalates and niobates. Titanium dioxide, zirconium dioxide and hafnium dioxide may likewise be prepared, in which connection the oxides may be doped with metals of other valency states, such as rare earth elements, for example yttrium, ytterbium or scandium. Ammonium dimolybdates, ammonium heptamolybdates, dimolybdates, heptamolybdates, paratungstates, ammonium paratungstate, spheroidal orthotungstic acid and molybdic acid may likewise advantageously be prepared by the process according to the invention.

Oxides of the rare earth metals can likewise be prepared. IRCS may advantageously be used to prepare spinels, perovskites and solid compounds having a rutile structure. Sparingly soluble halides and sulfides can likewise be obtained by the process according to the invention with a high space-time yield and high tap density. The process and IRCS according to the invention are especially suitable for the preparation of coated products, in that very different types of uniform coatings can be carried out in highly concentrated suspension.

In particular compounds can be prepared with this process that are particularly suitable as precursors for use in electrochemical cells and/or as electrode material in the production of fuel cells. These include nickel hydroxides or nickel oxyhydroxides, which can be doped with one or more divalent or trivalent metals such as for example Co, Zn, Mn, Al, and/or trivalent rare earth elements, though also coatings in the form of cobalt hydroxides or for example aluminium hydroxides may according to the invention be precipitated on base components, such as for example nickel hydroxides. Lithium/iron phosphates having defined physical properties can also be obtained via IRCS. Particularly preferably nickel/cobalt mixed hydroxides of the general formula NiₓCo₁₋ₓ(OH)₂ are prepared by the process according to the invention, which are preferably used as precursors in electrochemical cells and/or as electrode material in the production of fuel cells.

The present invention therefore provides pulverulent Ni,Co mixed hydroxides of the general formula NiₓCo₁₋ₓ(OH)₂ where 0<x<1, which have a BET surface, measured according to ASTM D 3663, of less than 20 m²/g and a tap density, measured according to ASTM B 527, of greater than 2.4 g/cm³. Preferably the Ni,Co mixed hydroxides have a BET surface of less than 15 m²/g and a tap density of greater than 2.45 g/cm³, particularly preferably a BET surface of less than 15 m²/g and a tap density of greater than 2.5 g/cm³ and most particularly preferably a BET surface of less than 15 m²/g and a tap density of greater than 2.55 g/cm³.

The pulverulent Ni,Co mixed hydroxides according to the invention are also characterised by the fact that they have a D₅₀ value, determined by means of MasterSizer according to ASTM B 822, of 3-30 μm, preferably of 10-20 μm. The Ni,Co mixed hydroxides according to the invention may be prepared having a spheroidal as well as a regular particle shape. The preferred Ni,Co mixed hydroxides according to the invention are characterised in particular by the spheroidal shape of the particles, the shape factor of which has a value of greater than 0.7, particularly preferably greater than 0.9. The shape factor of the particles may be determined according to the method mentioned in U.S. Pat. No. 5,476,530, columns 7 and 8 and the diagram. This method provides a shape factor of the particles that is a measure of the sphericity of the particles. The shape factor of the particles can also be determined from scanning electron microscopy images of the materials. The shape factor is determined by evaluating the particle circumference as well as the particle surface area and calculating the diameter derived from the respective quantity. The aforementioned diameters are given by the formula

d_{U}=U/π d_{A}=(4A/π)^{1/2}.

The shape factor of the particles f is derived from the particle circumference U and the particle surface area A according to the formula:

$$f = ( \frac{{d}_{A}}{{d}_{U}} ) = ( \frac{4 π A}{{U}^{2}} ) .$$

In the case of an ideal spherical particle d_{A} and d_{U} are equal in magnitude and a shape factor would be obtained from just one of these quantities.

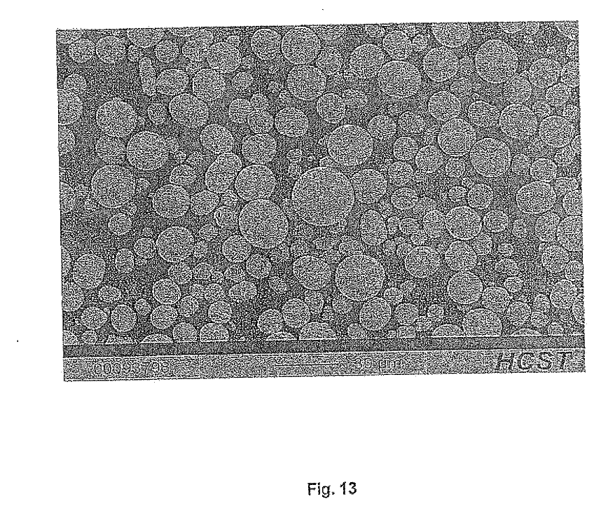

FIG. 13 shows by way of example an image obtained with a scanning electron microscope of the Ni,Co mixed metal hydroxide according to the invention prepared according to Example 1.

The use of the IRCS apparatus according to the invention and the process according to the invention thus significantly increases the flexibility compared to standard precipitations in conventional reactor systems, and the advantages resulting therefrom may be utilised for many different types of compounds. These advantages of the present invention can be summarised as follows:

a) Decoupling of the important process parameters for precipitations, such as educt concentrations, solids concentration and neutral salt concentration, and thus the attainment of new degrees of freedom that decisively improve the possibilities of a tailor-made product design.

b) By decoupling the solids residence time and mother liquor residence time, the space-time yield and thus the production rate is raised.

c) Creation of a completely new degree of freedom, in which a defined amount of fine fraction is removed from the system, whereby the particle grain distribution can be purposefully influenced and therefore the properties of the resulting product are influenced further as regards the predetermined profile regarded in each case as optimal from the application technology aspect.

The invention will be described in more detail with the aid of the following examples.

The physical parameters of the products specified in the examples are determined as follows:
The crystallite size is calculated from the half width of the 101 X-ray reflection.
The specific surface (BET) is determined according to ASTM D 3663.
The D₅₀ value is determined from the particle size distribution measured with MasterSizer.
The tap density is determined according to ASTM B 527.
The shape factor is determined according to the method disclosed in U.S. Pat. No. 5,476,530.

### EXAMPLES

### Example 1

The IRCS illustrated in FIG. 10 is filled with 200 litres of aqueous mother liquor containing 2 g/l NaOH, 13 g/l NH₃ and 130 g/l Na₂SO₄. The circulation pump (4) is then operated with a volume flow of 5 m³/hour, and pump (2) is operated with a volume flow of 90 l/hour. The pump (12) conveys the mother liquor from the inclined clarifier (5) to the circulation vessel (13), from where it flows back via the free overflow (15) into the IRCS. As soon as liquid leaves the overflow (15), the pump (17) commences operation and conveys mother liquor via the filter element (16) into the circulation vessel (18), from where it flows back via the free overflow (19) into the circulation vessel (13). The pump (17) is operated at a volume flow of 90 l/hour. After the stirrer (14) has been brought into operation at a speed of 300 r.p.m. and the stirrer (2) has been brought into operation at a speed of 544 r.p.m. and a temperature of 48° C. has been adjusted in the whole system by means of the heat exchanger (3), the metering pumps for the educt solutions are then brought into operation. The pump (6) conveys a metal sulfate solution containing 101.9 g/l nickel and 18.1 g/l cobalt at a volume flow of 25 l/hour. 5.6 l/hour of sodium hydroxide solution (NaOH) at a concentration of 750 g/l are metered in by the pump (7). The pump (8) conveys 3.1 l/hour of 25% ammonia solution and pump (9) conveys 21.8 l/hour of deonised water into the reactor. The pumps (21) and (22) are then switched on, and remove mother liquor from the system. The pump (21) conveys 46.9 l/hour to the waste water treatment unit, in which ammonia is also recovered. The pump (22) conveys 1 l/hour of the mother liquor to an automatic analysis instrument, where the ammonia content and excess sodium hydroxide are measured 3 times per hour. The pump (10) conveys the resultant product suspension with a solids content of 600 g/l via a filling level regulation device from the reactor to a suction filter connected downstream, where the suspension is filtered and washed. The reactor has reached a stationery state after 100 hours. The product formed within the following 24 hours is washed with 400 l of water and then dried in a drying cabinet at 80° C. to constant weight. 115 kg of Ni,Co mixed hydroxide (NiCo)(OH)₂ with the following product properties are obtained:

Crystallite size: 110 Angström

BET: 6.3 m²/g

D₅₀ value: 11.2 μm

Tap density: 2.46 g/cm³.

The scanning electron microscopy image in FIG. 13 shows the particular sphericity of the prepared Ni,Co mixed hydroxide, the shape factor of which is 0.8.

### Example 2

The IRCS illustrated in FIG. 10 is filled with 200 litres of aqueous mother liquor containing 2 g/l NaOH, 13 g/l NH₃ and 130 g/l Na₂SO₄. The circulation pump (4) is then operated with a volume flow of 5 m³/hour, and pump (2) is operated with a volume flow of 90 l/hour. The pump (12) conveys the mother liquor from the inclined clarifier (5) to the circulation vessel (13), from where it flows back via the free overflow (15) into the IRCS. As soon as liquid leaves the overflow (15), the pump (17) commences operation and conveys mother liquor via the filter element (16) into the circulation vessel (18), from where it flows back via the free overflow (19) into the circulation vessel (13). The pump (17) is operated at a volume flow of 90 l/hour. After the stirrer (14) has been brought into operation at a speed of 300 r.p.m. and the stirrer (2) has been brought into operation at a speed of 544 r.p.m. and a temperature of 48° C. has been adjusted in the whole system by means of the heat exchanger (3), the metering pumps for the educt solutions are then brought into operation. The pump (5) conveys a metal sulfate solution containing 101.9 g/l nickel and 18.1 g/l cobalt at a volume flow of 25 l/hour. 5.6 l/hour of sodium hydroxide (NaOH) at a concentration of 750 g/l are metered in by the pump (7). The pump (8) conveys 3.1 l/hour of 25% ammonia solution and pump (9) conveys 21.8 l/hour of deonised water into the reactor. The pumps (21) and (22) are then switched on, and remove mother liquor from the system. The pump (21) conveys 15.4 l/hour to the waste water treatment unit, in which ammonia is also recovered. The pump (22) conveys 1 l/hour of the mother liquor to an automatic analysis instrument, where the ammonia content and excess sodium hydroxide are measured 3 times per hour. 32 l/h of turbid solution with a solids content of 1.5 g/l are removed by the pump (23) from the IRCS (circulation vessel (10)). The pump (10) conveys the resultant product suspension with a solids content of 600 g/l via a filling level regulation device from the reactor to a suction filter connected downstream, where the suspension is filtered and washed. The reactor has reached a stationery state after 100 hours. The product formed within the following 24 hours is washed with 400 l of water and then dried in a drying cabinet at 80° C. to constant weight. 115 kg of Ni,Co mixed hydroxide (NiCo)(OH)₂ with the following product properties are obtained:

Crystallite size: 108 Angström

BET: 6.1 m²/g

D₅₀ value: 15.2 μm

Tap density: 2.54 g/cm³

Shape factor: 0.9

### Example 3

The IRCS illustrated in FIG. 11 is filled with 200 litres of aqueous mother liquor containing 5 g/l NaOH, 10 g/l NH₃ and 172 g/l Na₂SO₄. The circulation pump (4) is then operated with a volume flow of 5 m³/hour, and pump (2) is operated with a volume flow of 90 l/hour. The pump (12) conveys the mother liquor from the inclined clarifier (5) to the circulation vessel (13), from where it flows back via the free overflow (15) into the IRCS. As soon as liquid leaves the overflow (15), the pump (17) commences operation and conveys mother liquor via the filter element (16) into the circulation vessel (18), from where it flows back via the free overflow (19) into the circulation vessel (13). The pump (17) is operated at a volume flow of 90 l/hour. After the stirrer (14) has been brought into operation at a speed of 300 r.p.m. and the stirrer (2) has been brought into operation at a speed of 480 r.p.m. and a temperature of 45° C. has been adjusted in the whole system by means of the heat exchanger (3), the metering pumps for the educt solutions are then brought into operation. The pump (6) conveys 20.4 l/h of a metal sulfate solution containing 109.6 g/l nickel, 2.84 g/l cobalt and 7.57 g/l zinc. 4.62 l/hour of sodium hydroxide solution (NaOH) at a concentration of 750 g/l are metered in by the pump (7). The pump (8) conveys 1.51 l/hour of 25% ammonia solution and pump (9) conveys 8.29 l/hour of deonised water into the reactor. The pumps (21) and (22) are then switched on, and remove mother liquor from the system. The pump (21) conveys 3.0 l/hour to the waste water treatment unit, in which ammonia is also recovered. The pump (22) conveys 1 l/hour of the mother liquor to an automatic analysis instrument, where the ammonia content and excess sodium hydroxide are measured 3 times per hour. 20.5 l/h of turbid solution with a solids content of 2.0 g/l are removed by the pump (23) from the IRCS (circulation vessel (10)). The pump (10) conveys the resultant product suspension with a solids content of 360 g/l via a filling level regulation device from the reactor to a suction filter connected downstream, where the suspension is filtered and washed. The reactor has reached a stationery state after 90 hours. The product formed within the following 24 hours is washed with 400 l of water and then dried in a drying cabinet at 80° C. to constant weight. 93 kg of Ni,Co,Zn mixed hydroxide (Ni,Co,Zn)(OH)₂ with the following product properties are obtained:

Crystallite size: 67 Angström

BET: 10.1 m²/g

D₅₀ value: 15.1 μm

Tap density: 2.40 g/cm³

Shape factor: 0.75

### Comparison Example 1

The IRCS illustrated in FIG. 10 is filled with 200 litres of aqueous mother liquor containing 2 g/l NaOH, 13 g/l NH₃ and 130 g/l Na₂SO₄. The circulation pump (4) is then operated with a volume flow of 5 m³/hour, and pump (2) is operated with a volume flow of 90 l/hour. The pump (12) conveys the mother liquor from the inclined clarifier (5) to the circulation vessel (13), from where it flows back via the free overflow (15) into the IRCS. As soon as liquid leaves the overflow (15), the pump (17) commences operation and conveys mother liquor via the filter element (16) into the circulation vessel (18), from where it flows back via the free overflow (19) into the circulation vessel (13). The pump (17) is operated at a volume flow of 90 l/hour. After the stirrer (14) has been brought into operation at a speed of 300 r.p.m. and the stirrer (2) has been brought into operation at a speed of 544 r.p.m. and a temperature of 48° C. has been adjusted in the whole system by means of the heat exchanger (3), the metering pumps for the educt solutions are then brought into operation. The pump (6) conveys a metal sulfate solution containing 101.9 g/l nickel and 18.1 g/l cobalt at a volume flow of 4.01 l/hour. 0.89 l/hour of sodium hydroxide solution (NaOH) at a concentration of 750 g/l are metered in by the pump (7). The pump (8) conveys 0.50 l/hour of 25% ammonia solution and pump (9) conveys 3.49 l/hour of deonised water into the reactor. The pump (22) is then switched on, which removes 1 l/hour of mother liquor from the system and passes it to an automatic analysis device, where the ammonia content and excess sodium hydroxide are measured 3 times per hour. The pump (10) conveys the resultant product suspension with a solids content of 96 g/l via a filling level regulation device from the reactor to a suction filter connected downstream, where the suspension is filtered and washed. The reactor has reached a stationery state after 100 hours. The product formed within the following 24 hours is washed with 400 l of water and then dried in a drying cabinet at 80° C. to constant weight. 115 kg of Ni,Co mixed hydroxide (NiCo)(OH)₂ with the following product properties are obtained:

Crystallite size: 106 Angström

BET: 13.1 m²/g

D₅₀ valueTGV : 21.3 μm

Tap density: 2.23 g/cm³.

### Comparison Example 2

The IRCS illustrated in FIG. 10 is filled with 200 litres of aqueous mother liquor containing 5 g/l NaOH, 10 g/l NH₃ and 172 g/l Na₂SO₄. The circulation pump (4) is then operated with a volume flow of 5 m³/hour, and pump (2) is operated with a volume flow of 90 l/hour. The pump (12) conveys the mother liquor from the inclined clarifier (5) to the circulation vessel (13), from where it flows back via the free overflow (15) into the IRCS. As soon as liquid leaves the overflow (15), the pump (17) commences operation and conveys mother liquor via the filter element (16) into the circulation vessel (18), from where it flows back via the free overflow (19) into the circulation vessel (13). The pump (17) is operated at a volume flow of 90 l/hour. After the stirrer (14) has been brought into operation at a speed of 300 r.p.m. and the stirrer (2) has been brought into operation at a speed of 480 r.p.m. and a temperature of 45° C. has been adjusted in the whole system by means of the heat exchanger (3), the metering pumps for the educt solutions are then brought into operation. The pump (6) conveys a metal sulfate solution containing 109.6 g/l nickel, 2.84 g/l cobalt and 7.57 g/l zinc at a volume flow of 6.69 l/hour. 1.52 l/hour of sodium hydroxide solution (NaOH) at a concentration of 750 g/l are metered in by the pump (7). The pump (8) conveys 1.51 l/hour of 25% ammonia solution and pump (9) conveys 8.29 l/hour of deonised water into the reactor. The pump (22) is then switched on, which conveys 1 l/hour of mother liquor to an automatic analysis instrument, where the ammonia content and excess sodium hydroxide are measured 3 times per hour. The pump (10) conveys the resultant product suspension with a solids content of 120 g/l via a filling level regulation device from the reactor to a suction filter connected downstream, where the suspension is filtered and washed. The reactor has reached a stationery state after 90 hours. The product formed within the following 24 hours is washed with 150 l of water and then dried in a drying cabinet at 80° C. to constant weight. 30.5 kg of Ni,Co,Zn mixed hydroxide (NiCoZn)(OH)₂ with the following product properties are obtained:

Crystallite size: 63 Angström

BET: 12.0 m²/g

D₅₀ value: 11.9 μm

Tap density: 2.21 g/cm³.

1. Device for the preparation of compounds by precipitation in a reactor, characterised in that the reactor comprises an inclined clarifier.

2. Device according to claim 1, characterised in that the angle of inclination of the inclined clarifier is 20° to 85°.

3. Device according to claim 1, characterised in that the angle of inclination of the inclined clarifier is 40° to 70°.

4. Device according to claim 1, characterised in that the inclined clarifier contains a lamella or lamellae mounted in a plane-parallel manner with respect to the floor surface.

5. Device according to claim 4, characterised in that the inclined clarifier contains at least one lamella.

6. Device according to claim 1, characterised in that the inclined clarifier comprises internally and laterally on each side a height adjustable rail system consisting of at least one pair of rails.

7. Device according to claim 1, characterised in that the inclined clarifier comprises internally and laterally on each side at least one groove for receiving lamellae.

8. Device according to claim 6, characterised in that the lamellar or lamellae are mounted on the rail(s).

9. Device according to claim 7, characterised in that lamellar/lamellae is/are inserted into the groove(s).

10. Device according to claim 4, characterised in that the lamellae are at least 0.5 cm thick.

11. Device according to claim 1, characterised in that the inclined clarifier comprises at the inflow in the interior of the reactor a plate which is arranged in a plane-parallel manner to the opening of the entry surface of the inclined clarifier.

12. Use of the device according to claim 1 for the preparation of compounds by precipitation.

13. Process for the preparation of compounds by precipitation, consisting of the following steps:
Provision of at least a first and a second educt solution,
Combined feed of at least the first and the second educt solution to a reactor according to claim 1,
Generation of a homogeneously intensively mixed reaction zone in the reactor,
Precipitation of the compounds in the reaction zones and formation of a product suspension consisting of insoluble product and mother liquor,
Partial separation of the mother liquor from the precipitated product via the inclined clarifier,
Preparation of a precipitation product—suspension, the concentration of the precipitation product of which is greater than the stoichiometric concentration,
Removal of the product suspension from the reactor,
Filtration and drying of the precipitated product.

14. Process according to claim 13, characterised in that the partial separation of the mother liquor is carried out by direct removal of the overflow of the inclined clarifier.

15. Process according to claim 14, characterised in that the overflow of the inclined clarifier comprises 0 to 50% of the solids content of the product suspension.

16. Process according to claim 14, characterised in that the overflow of the inclined clarifier comprises 0 to 30% of the solids content of the product suspension.

17. Process according to claim 14, characterised in that the overflow of the inclined clarifier comprises 0 to 15% of the solids content of the product suspension.

18. Process according to claim 14, characterised in that the maximum particle size in the overflow of the inclined clarifier is 30% of the D₅₀ value of the particle size distribution.

19. Process according to claim 13, characterised in that the concentration of the precipitation product in the suspension is a multiple of the stoichiometric amount.

20. Process according to claim 13, characterised in that up to 90% of the mother liquor is partially separated.

21. An inorganic compound obtainable according to claim 13.

22. Pulverulent Ni,Co mixed hydroxide of the general formula NiₓCo₁₋ₓ(OH)₂, where 0<x<1, characterised in that it has a BET surface, measured according to ASTM D 3663, of less than 20 m²/g and a tap density, measured according to ASTM B 527, of greater than 2.4 g/cm³.

23. Pulverulent Ni,Co mixed hydroxide according to claim 22, characterised in that it has a BET surface, measured according to ASTM D 3663 of less than 15 m²/g and a tap density, measured according to ASTM B 822, of greater than 2.45 g/cm³.

24. Pulverulent Ni,Co mixed hydroxide according to claim 22, characterised in that it has a BET surface, measured according to ASTM D 3663, of less than 15 m²/g and a tap density, measured according to ASTM B 822, of greater than 2.5 g/cm³.

25. Pulverulent Ni,Co mixed hydroxide according to claim 22, characterised in that it has a BET surface, measured according to ASTM D 3663, of less than 15 m²/g and a tap density, measured according to ASTM B 822, of greater than 2.55 g/cm³.

26. Pulverulent Ni,Co mixed hydroxide according to claim 22, characterised in that it has a D₅₀ value determined by means of MasterSizer according to ASTM B 822 of 3-30 μm.

27. Pulverulent Ni,Co mixed hydroxide according to claim 22, characterised in that it has a D₅₀ value determined by means of MasterSizer according to ASTM B 822 of 10-20 μm.

28. Pulverulent Ni,Co mixed hydroxide according to claim 22, characterised in that the powder particles have a spheroidal shape.

29. Pulverulent Ni,Co mixed hydroxide according to claim 22, characterised in that the powder particles have a shape factor of greater than 0.7.

30. Pulverulent Ni,Co mixed hydroxide according to claim 22, characterised in that the powder particles have a shape factor of greater than 0.9.

31. Use of the pulverulent Ni,Co mixed hydroxide according to claim 22, for the production of electrochemical cells.

32. Use of the pulverulent Ni,Co mixed hydroxide according to claim 22, as electrode material in the production of fuel cells.
